(19) United States
(12) Patent Application Publication
(10) Pub. No.: US 2026/0092594 A1
(43) Pub. Date: Apr. 2, 2026

(54) SYSTEM AND METHOD FOR ESTIMATING WIND FARM POWER OUTPUT

(71) Applicant: BP P.L.C., London (GB)

(72) Inventor: Leong Kit Gan, Reading (GB)

(73) Assignee: BP P.L.C., London (GB)

(21) Appl. No.: 19/322,931

(22) Filed: Sep. 9, 2025

(30) Foreign Application Priority Data
Sep. 27, 2024 (GB) 2414234.1

(51) Int. Cl. F03D 17/00

(52) U.S. Cl. CPC F03D 17/021; F03D 17/006; F03D 17/007; F05B 2200/11; F05B 2200/12; F05B 2200/13; F05B 2200/14; F05B 2200/22; F05B 2270/3202; F05B 2270/321; F05B 2270/335; F05B 2270/342

(57) ABSTRACT

A system and method for predicting power output of a wind farm are disclosed. The method includes determining first and second parameter values of a power curve for a plurality of wind turbines. A second relationship is determined between the densities associated with the wind turbines and the values of the first parameter. A third relationship is determined between the densities associated with the wind turbines and the values of the second parameter. A value of the first parameter for a specified wind farm density is determined based on the second relationship. A value of the second parameter for the specified wind farm density is determined based on the third relationship. An indication of a power output for the specified wind farm density is generated by applying the determined values of the first and second parameters to the power curve.

### CROSS-REFERENCE TO RELATED APPLICATION

This application claims priority to and the benefit of GB Patent Application No. 2414234.1, filed on Sep. 27, 2024, which is incorporated by reference herein in its entirety.

### BACKGROUND

Wind turbines convert the kinetic energy of wind into electrical power. The efficiency and profitability of a group of wind turbines (e.g., a wind farm) are dependent on a power output of the wind farm, which may be normalized on a per turbine basis. Such a normalized power output is influenced by numerous factors, including wind speed, turbine design, and the layout of the wind farm.

Predicting the power output of a wind farm is difficult. Some methods rely on simplified models that consider limited data, or on complex calculations that require large datasets. Simplified models generally provide less accurate estimates, while complex calculations are computationally expensive, and thus inefficient. Also, the wake effect affects power production, particularly for wind farms with higher turbine densities. The wake effect can reduce the wind speed and increase turbulence for downstream turbines, which results in a lower energy output than expected.

### SUMMARY

In an embodiment, a method includes determining a value of a first parameter of a first relationship between a wind speed and a power output for each of a plurality of wind turbines. The method further includes determining a value of a second parameter of the first relationship for each of the plurality of wind turbines. The values of the first parameter and the second parameter are based on historical power output data for each of the plurality of wind turbines. Also, at least some of the plurality of wind turbines are associated with wind farms having different densities. Further, the method includes determining a second relationship between the densities associated with the wind turbines and the values of the first parameter. Additionally, the method includes determining a third relationship between the densities associated with the wind turbines and the values of the second parameter. The method further includes determining a value of the first parameter for a specified wind farm density based on the second relationship. Additionally, the method includes determining a value of the second parameter for the specified wind farm density based on the third relationship. Further, the method includes generating an indication of a power output for the specified wind farm density by applying the determined values of the first and second parameters to the first relationship.

In another embodiment, an electronic device includes one or more processors and a memory coupled to the one or more processors and storing instructions. The stored instructions, when executed by the one or more processors, cause the electronic device to be configured to determine a value of a first parameter of a first relationship between a wind speed and a power output for each of a plurality of wind turbines. The stored instructions, when executed by the one or more processors, cause the electronic device to be further configured to determine a value of a second parameter of the first relationship for each of the plurality of wind turbines. The values of the first parameter and the second parameter are based on historical power output data for each of the plurality of wind turbines. Also, at least some of the plurality of wind turbines are associated with wind farms having different densities. Further, the stored instructions, when executed by the one or more processors, cause the electronic device to be configured to determine a second relationship between the densities associated with the wind turbines and the values of the first parameter. Additionally, the stored instructions, when executed by the one or more processors, cause the electronic device to be configured to determine a third relationship between the densities associated with the wind turbines and the values of the second parameter. The stored instructions, when executed by the one or more processors, cause the electronic device to be further configured to determine a value of the first parameter for a specified wind farm density based on the second relationship. Additionally, the stored instructions, when executed by the one or more processors, cause the electronic device to be configured to determine a value of the second parameter for the specified wind farm density based on the third relationship. Further, the stored instructions, when executed by the one or more processors, cause the electronic device to be configured to generate an indication of a power output for the specified wind farm density by applying the determined values of the first and second parameters to the first relationship.

In another embodiment, a non-transitory computer-readable medium includes stored instructions. The stored instructions, when executed by the one or more processors, cause the electronic device to be configured to determine a value of a first parameter of a first relationship between a wind speed and a power output for each of a plurality of wind turbines. The stored instructions, when executed by the one or more processors, cause the electronic device to be further configured to determine a value of a second parameter of the first relationship for each of the plurality of wind turbines. The values of the first parameter and the second parameter are based on historical power output data for each of the plurality of wind turbines. Also, at least some of the plurality of wind turbines are associated with wind farms having different densities. Further, the stored instructions, when executed by the one or more processors, cause the electronic device to be configured to determine a second relationship between the densities associated with the wind turbines and the values of the first parameter. Additionally, the stored instructions, when executed by the one or more processors, cause the electronic device to be configured to determine a third relationship between the densities associated with the wind turbines and the values of the second parameter. The stored instructions, when executed by the one or more processors, cause the electronic device to be further configured to determine a value of the first parameter for a specified wind farm density based on the second relationship. Additionally, the stored instructions, when executed by the one or more processors, cause the electronic device to be configured to determine a value of the second parameter for the specified wind farm density based on the third relationship. Further, the stored instructions, when executed by the one or more processors, cause the electronic device to be configured to generate an indication of a power output for the specified wind farm density by applying the determined values of the first and second parameters to the first relationship.

Embodiments described herein include a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIGS. 1A and 1B are graphs of relationships between a wind farm power output and wind speed for a specified wind farm density, in accordance with embodiments described herein.

FIGS. 2A-2F are scatter plots depicting relationships between turbine density and various parameters of a wind turbine power curve model in accordance embodiments described herein.

FIG. 3 is a schematic illustration of a wake model applied to an example wind farm in accordance with embodiments described herein.

FIG. 4 is a flowchart of a method for estimating wind farm power output in accordance with embodiments described herein.

FIG. 5 is a block diagram of a system in accordance with embodiments described herein.

FIG. 6 is a flowchart of a method for controlling energy distribution in an electrical system in accordance with embodiments described herein.

FIG. 7 is a block diagram of a computer system configurable to implement one or more embodiments described herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct engagement between the two devices, or through an indirect connection that is established via other devices, components, nodes, and connections. In addition, as used herein, the terms “axial” and “axially” generally mean along or parallel to a particular axis (e.g., a central axis of a body or a port), while the terms “radial” and “radially” generally mean perpendicular to a particular axis. For instance, an axial distance refers to a distance measured along or parallel to the axis, and a radial distance means a distance measured perpendicular to the axis. Any reference to up or down in the description and the claims is made for purposes of clarity, with “up,” “upper,” “upwardly,” “uphole,” or “upstream” meaning toward the surface of the borehole and with “down,” “lower,” “downwardly,” “downhole,” or “downstream” meaning toward the terminal end of the borehole, regardless of the borehole orientation. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Accurately and efficiently estimating the power output of a wind farm is difficult due at least to the impact of wake effects. Wake effects occur when wind flow is disrupted by upstream turbines, creating turbulence and reducing wind speed for downstream turbines. This results in a decrease in power output for the affected turbines and can impact the overall energy production of the wind farm. Wake effect complications arise from their dependence on numerous factors, including wind speed and direction, wind farm density and layout, atmospheric conditions, and terrain characteristics. These factors may interact in complex ways, making it challenging to accurately predict the wake effects and their impact on power output.

Traditional methods for improving wind farm power output typically rely on complex computational simulations (e.g., computational fluid dynamics (CFD)) or simplified mathematical wind flow models (e.g., analytical wake models). While complex computational simulations offer accuracy, they are computationally expensive. Simplified mathematical models are generally faster but may lack accuracy. Thus, using conventional approaches, it is generally difficult to quickly and accurately estimate the power output of a given wind farm.

The embodiments described herein address the foregoing by determining relationships between wind farm densities (e.g., number of turbines per unit area) and parameters of a model (e.g., a formula) for wind farm power output, enabling a relatively simple estimation of an indication of power output for a wind farm having a given density. In some examples, the model for wind farm power output is selected to take into account wake effects. For example, wind farm parameters may include an incident wind speed, an incident wind direction, a power output saturation (e.g., peak power generated by a wind turbine), a rate of growth, a wind speed range associated with a greatest rate of change of power (e.g., a range having a first derivative greater than a predetermined threshold), wake effects (e.g., a peak location, a peak height, a peak width), a wind turbine cut-in speed (e.g., a minimum wind speed required for the turbine to generate electricity), and a wind turbine cut-out speed (e.g., a rated wind turbine output, or a maximum power a single turbine can generate). Relationships between wind farm densities, parameters, and power outputs may be identified by utilizing machine learning to analyze a large amount of data from wind farm simulations and historical data from diverse wind farms.

In at least some embodiments, the power output model represents power output as a function of wind speed, and can represent power output at the wind farm level, or as a normalized, per-turbine power output. Applying the power output model to wind farm layouts with varying densities generates multiple power curves. Thus, each power curve is associated with a particular density. Subsequently, a relationship is established between values of a particular model parameter (i.e., the values of that parameter for the multiple power curves) and the densities associated with the various power curves. Such a relationship may be established for multiple of the model parameters. Model parameters may include an incident wind speed, an incident wind direction, a power output saturation, a rate of growth, a wind speed range associated with a greatest rate of change of power, a shaping parameter, a wake peak center, a wake peak height, and a wake peak width.

In some examples, these relationships may be a curve that is fitted to the values of a particular model parameter as a function of wind farm density. The relationships between various model parameters and density may be independent of wake effects. Accordingly, these relationships enable relatively straightforward interpolation (or extrapolation) of model parameter values for a given wind farm density. Thus, for a given wind farm density, parameter values can be relatively quickly estimated, and applied to the power curve model to generate a power curve specific to the given wind farm density. Such power curve may be subsequently applied to determine a power output of the wind farm (or normalized on a per-turbine basis for the wind farm) for a given wind speed. The embodiments described herein thus enable a relatively accurate and computationally-efficient prediction of wind farm power output, which can in turn enable more informed decision-making (including occurring in near real-time) in wind farm planning, design, and operation.

In at least some examples, the embodiments described herein may be more suitable for implementation in hardware (e.g., a field-programmable gate array (FPGA) or an application-specific integrated circuit (ASIC)). By deploying the model on an FPGA, wind farm operators may quickly obtain power output predictions, allowing them to adjust turbine control settings or grid integration strategies in response to changing wind conditions. Such capability may be valuable for improving wind farm performance and energy capture. For example, the model may be used to predict the impact of wake effects on downstream turbines and adjust the yaw angles of upstream turbines to minimize power losses. Additionally, the model may inform grid integration decisions, allowing for stable and efficient power delivery from the wind farm to the electrical grid. The ability to run the model through hardware-in-the-loop (HIL) simulations or control prototyping may also facilitate the development and validation advanced wind farm control algorithms. By testing control strategies in a realistic environment, engineers may be able to identify and address potential issues before deploying them in actual wind farms. By contrast, CFD-based models are poorly suited for hardware implementation, because of their relative complexity.

In this way, the embodiments described herein leverage historical and simulated wind farm data to model or estimate power output for a wind farm (having a given density) as a function of wind speed. By identifying relationships between wind farm density and various parameters of the power curve model, the power output of a wind farm of a given density can be estimated relatively accurately and with improved speed.

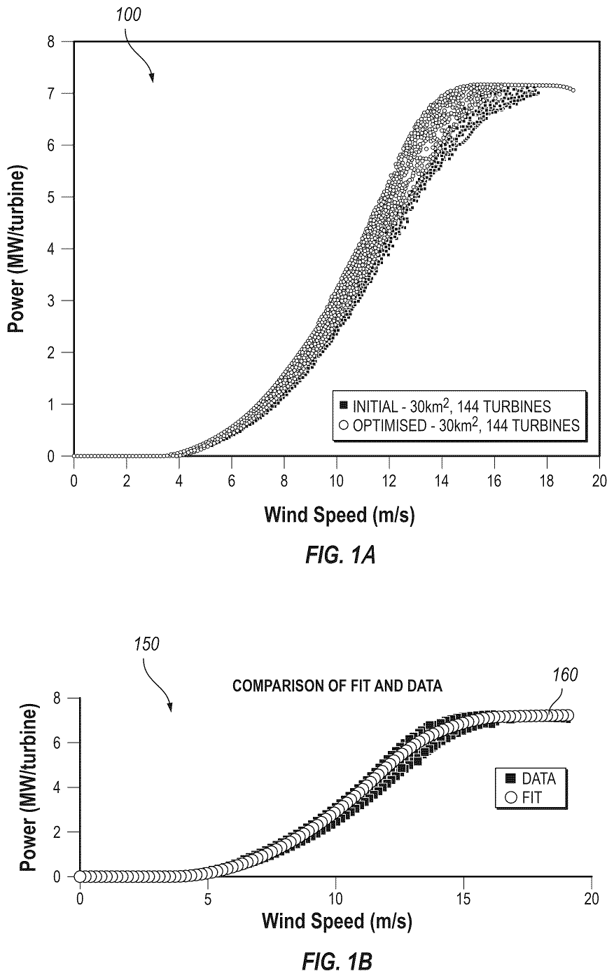

FIGS. 1A and 1B show graphs 100 and 150, respectively, that represent relationships between power output and wind speed of wind farms with a particular density (e.g., 144 turbines over a 30 km² area). More specifically, the graph 100 in FIG. 1A is a scatter plot 100 of data points that show power output comparisons between initially random and subsequently optimized turbine placements. The graph 150 in FIG. 1B illustrates an exemplary power curve 160 for a wind farm fitted to the optimized data points shown in FIG. 1A. In both graphs 100, 150, the x-axis represents the wind speed in meters per second (m/s), and the y-axis represents the power output in megawatts per turbine (MW/turbine). The graph 150 in FIG. 1A demonstrates that, at least in some examples, optimizing turbine placement yields a higher power output for a given wind speed.

Power curves generally aid in visualizing relationships between various power outputs and other factors (e.g., wind speed on the x-axis and power output of wind farms or wind turbines on the y-axis). Power curves (e.g., the exemplary power curve 160 in FIG. 1B) may be represented by mathematical functions. One such mathematical function is the generalized logistic function:

$${f}_{r} ( v ) = \frac{s + b}{{[ 1 + {e}^{- r ( v - {v}_{t} )} ]}^{p}} - c \qquad Equation 1$$

In Equation 1, v is a value of an incident wind speed, s is a value of a power output saturation, r is a value of a rate of growth, vₜ is a value of a wind speed range associated with greatest rate of change of power, p is a value of a shaping parameter, b and c are constants chosen such that fᵣ(v_{cut-in})=0 and fᵣ(v_{cut-out})=s, and e is Euler's number (a mathematical constant approximately equal to 2.71828). Here, v_{cut_in} is referred to as the cut-in speed and v_{cut-out} is referred to as the cut-out speed. The cut-in speed refers to the lowest wind speed required for a turbine to start rotating and generating electricity. Below this speed, wind energy may be insufficient to overcome the inertia and friction of a turbine, and a turbine may remain idle. The cut-out speed, also known as rated output, refers to a wind speed above which a turbine may no longer produce additional power. At this wind speed, a turbine may be set to shut down automatically, as exceeding this speed may cause structural damage to the turbine. Rated speed (v_{rated}) refers to as the wind speed at which a turbine may reach its maximum (rated) power output. Beyond this point, the control systems of a turbine may regulate the power output to protect a generator and other components from excessive wind speeds.

Saturation power (s) refers to the maximum (or peak) power output that a wind turbine can produce, typically achieved at or above the rated speed. It may represent the upper limit of the energy generation capacity of the turbine. Rate of growth (r) refers to the slope of the power curve between the cut-in speed and the rated speed, indicating how quickly power output increases with wind speed. A steeper slope may indicate that power output of a turbine increases more rapidly with wind speed, which may generally be desirable for efficient energy capture. Wind speed range associated with the greatest rate of change of power (vₜ) refers to the wind speed range where the power curve exhibits the steepest slope. This may indicate the most efficient operating range for the turbine (or wind farm), where a turbine may generate the most power for a given increase in wind speed. The shaping parameter (p) is a parameter that controls the overall shape and curvature of the power curve, allowing for adjustments based on specific turbine designs and operating conditions (e.g., fine-tuning a model to match specific characteristics of different turbine designs and operating conditions).

The power produced may not depend on an incident angle for wind farms with random turbine layouts. However, for wind farms with positional structures, the incident angle may need to be considered. For such wind farms, a modified power curve, including a directional component, may be represented by the logistic function:

$${f}_{g} ( v , w ) = {f}_{r} ( v ) ( 1 - {p}_{h} ( {e}^{- s {\vert w - {p}_{c} \vert}^{{p}_{s}}} ) ) \qquad Equation 2$$

In Equation 2, w is a value of an incident wind direction, p_{c} is a value of a wake peak center, pₕ is a value of a wake peak height, and pₛ is a value of a wake peak width. Equation 2 represents power output for a wind turbine taking into account both wind speed and wind direction, whereas Equation 1 represents power output as a function of wind speed only. Wake peak center is the wind direction at which the wake effect is most pronounced (e.g., the wind angle at which power drops due to wake effects). Wake peak height is the maximum reduction in power output due to wake effects (e.g., the amount that power generation drops). Wake peak width determines the range of wind directions affected by wake effects (e.g., broadness of angular effect). Equation 2 may provide a more robust way to predict power output of wind turbines in a wind farm setting. Incorporating the wake effect may account for interactions between turbines, which may aid in improving wind farm layout and energy production.

While the exemplary power curve 160 may be representative of typical wind turbine power curves, the actual shape and parameters of a power curve can vary depending on the specific turbine and wind farm design, size, and operating environments. The formula parameters may be estimated from historical wind and power data, for example, by using machine learning techniques. This may allow for the generation of customized power curves for different wind farm densities and layouts, which may lead to more efficient and cost-effective wind energy projects. Further, these functions may model the behavior of a wind farm under varying wind conditions, taking into account factors such as aerodynamic efficiency, mechanical losses, and control strategies.

By analyzing power curves from a plurality of wind turbines and correlating the parameters with wind farm density, as described and shown, it may be possible to predict the power output of a wind farm with a specified (e.g., new or planned) wind farm density and wind speed. This information may also be useful for improving wind farm design, operation, and integration into an electrical grid.

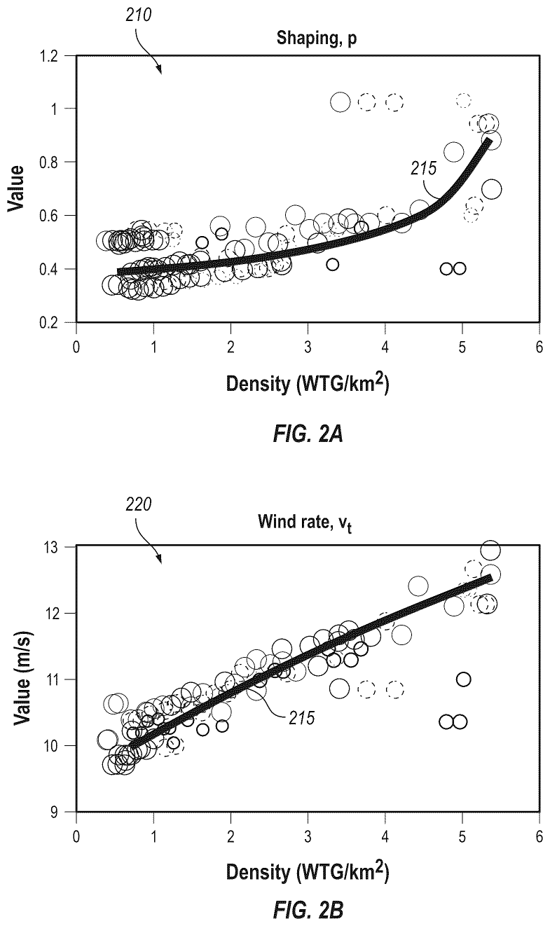

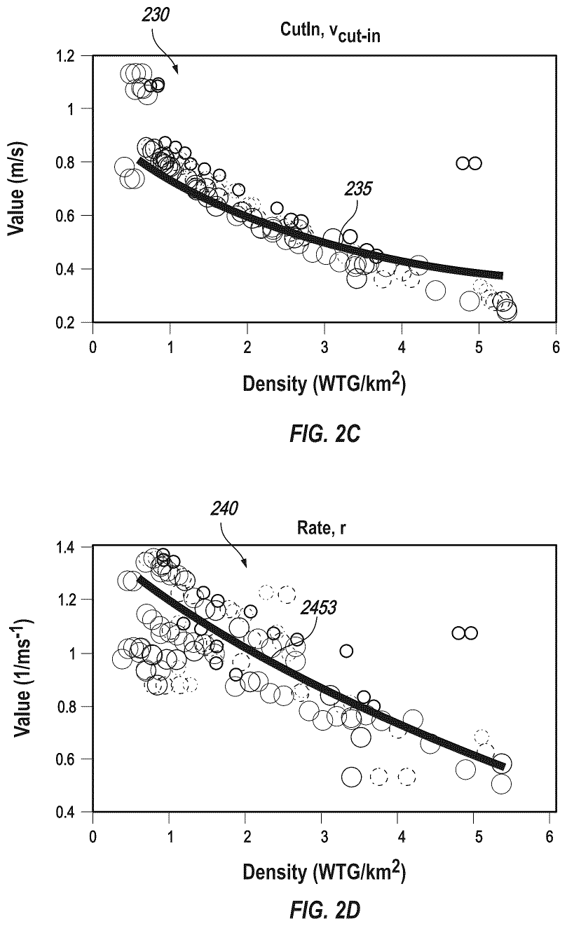

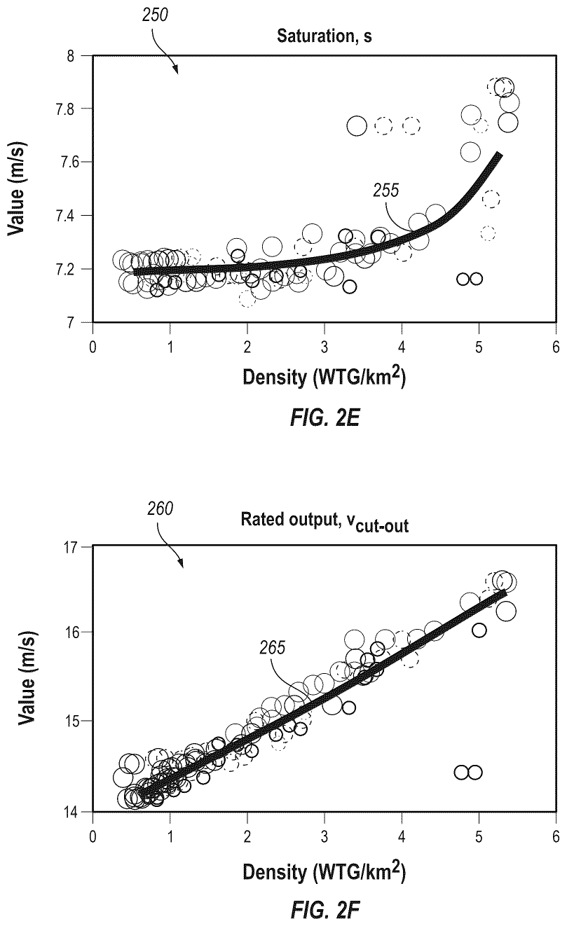

Now turning to FIGS. 2A-2F, graphical illustrations of relationships between turbine density and power curve parameters of a wind turbine power curve model are shown in a collection of scatter plots. Each of FIGS. 2A-2F is a plot of one of the parameters of the power curve model as a function of wind turbine density. In these examples, density is represented as a number of wind turbine generators (WTGs) per square kilometer (km²). Such scatter plots and associated fit curves may be generated by utilizing Equation 1 or Equation 2, and may also be generated for parameters of other exemplary power curve models.

FIG. 2A shows a graph 210 of shaping parameter values for multiple different wind turbines (e.g., associated with wind farms having different densities) as a function of the associated wind farm density. The graph 210 illustrates how the shaping parameter may change with increasing wind farm density. In some examples, a fitted curve 215 is generated based on the shaping parameter values in the graph 210.

The shaping parameter may control aspects of the curvature of the power curve, influencing how quickly the power output increases with wind speed and at what point it may reach saturation. A slight positive correlation, as the fitted curve 215 demonstrates, may suggest that denser wind farms may have power curves with slightly more gradual transitions to saturation. This may be due to the wake effect reducing the wind speed experienced by the wind turbines such that the average actual (e.g., environmental) wind speed required for a wind farm to produce the same amount of power increases. However, in the graph 210, the plotted data of the shaping parameter does not necessarily show a conclusive trend, particularly at higher density values, and may provide less insight than other parameters. This may be due to the lack of data available for higher wind farm densities. If there is little to no correlation between density and the shaping parameter, it may imply that the overall shape of the power curve remains relatively consistent across different wind farm densities. This may suggest that the wake effects, which are more pronounced in denser wind farms, do not substantially alter the fundamental shape of the power curve for individual turbines. Generally, the relationship between density and the shaping parameter may become non-linear as the wake effect becomes more pronounced at higher densities.

FIG. 2B shows a graph 220 of wind rate values for multiple different wind turbines as a function of the associated wind farm density. The graph 220 illustrates how the wind rate parameter may change with increasing wind farm density. In some examples, a fitted curve 225 is generated based on the wind rate parameter values in the graph 220.

The fitted curve 225 illustrates a positive correlation between wind farm density and the average wind speed at which the power output increases most rapidly. This correlation may show that as the number of turbines per square kilometer increases, the average wind speed at which turbines achieve their peak efficiency also increases. The power output of a wind turbine itself is generally fixed at a particular wind speed it experiences. For example, if the power output of a wind turbine is 3 MW at a wind speed of 5 m/s, then the wind turbine produces 3 MW when it experiences 5 m/s wind speed regardless of wind farm density. When the density of a wind farm increases, the wind speed experienced by a wind turbine may drop (e.g., to 4 m/s), reducing the power output of the wind turbine.

Accordingly, the fitted curve 225 shows that as wind farm density increases, the wind rate also tends to increase, which may indicate that more dense wind farms reach peak efficiency at higher wind speeds. This may be due to the wake effect, where upstream turbines reduce the wind speed and turbulence for downstream turbines, shifting a desired operating range to higher wind speeds. This reduced wind speed and increased turbulence may shift the desired operating point of the turbines to higher wind speeds, where they can still extract enough energy to reach their peak efficiency. In this example, the overall trend is generally positive; however, the relationship between density and wind rate may not be perfectly linear. There may be a point of diminishing returns where further increases in density do not lead to changes in the wind rate.

FIG. 2C shows a graph 230 of cut-in wind speed values for multiple different wind turbines as a function of the associated wind farm density. The graph 230 illustrates how the cut-in wind speed may change with increasing wind farm density. In some examples, a fitted curve 235 is generated based on the cut-in wind speed values in the graph 230.

As illustrated in this example, there is a negative correlation in fitted curve 235. However, such a correlation may not be conclusively established as the differences in cut-in speed relative to wind farm density in the graph 230 are incremental (e.g., at 3 m/s within a delta of 2.5×10⁻⁵). This likely signifies that there is no substantive correlation between cut-in speed and wind farm density. Thus, it may be concluded that cut-in speed remains constant as a function of density.

FIG. 2D shows a graph 240 of rate of growth values for multiple different wind turbines as a function of the associated wind farm density. The graph 2402 illustrates how the rate of growth may change with increasing wind farm density. In some examples, a fitted curve 245 is generated based on the rate of growth values in the graph 240.

As shown in the fitted curve 245, the negative correlation between wind farm density and the rate of growth (e.g., rate of power increase) may mean that as the number of turbines per square kilometer increases, the rate at which the power output increases with wind speed decreases. A driver of this negative correlation may, again, be wake effects. In denser wind farms, the wake generated by upstream turbines may disrupt the airflow and reduce the wind speed experienced by downstream turbines. This reduction in wind speed not only may affect the overall power output but also may diminish the rate at which power can increase with increasing wind speeds. In simpler terms, the turbines in denser wind farms may have less room to ramp up their power production as the wind gets stronger. The relationship between density and the rate of power increase may not be strictly linear. It may be that the rate of decrease in r becomes less pronounced at high densities, suggesting a possible saturation point beyond which further increases in density have a diminishing impact on the rate of power increase.

FIG. 2E shows a graph 250 of saturation parameter values for multiple different wind turbines as a function of the associated wind farm density. The graph 250 illustrates how the saturation parameter of the power curve model may change with increasing wind farm density. In some examples, a fitted curve 255 is generated based on the saturation parameter values in the graph 250.

The fitted curve 255 may suggest that increasing wind farm density may increase the saturation power output for turbines. For example, as wind farm density increases, the spacing between turbines decreases, leading to a higher concentration of turbines in a given area. This increased density may result in a phenomenon where some upstream turbines experience a higher effective wind speed due to the channeling effect of neighboring turbines. This higher wind speed may, in turn, lead to a slightly elevated average power output for those turbines. However, this effect may be counterbalanced by the increased wake effects in denser wind farms. As more turbines are packed together, the wake interactions may become more pronounced, leading to a reduction in wind speed and power output for downstream turbines. Similar to the graph 210 of shaping parameter values, the fitted curve 255 in the graph 250 does not necessarily show a conclusive trend at higher density values, and thus, may provide less insight than other parameters.

FIG. 2F shows a graph 260 of rated output (i.e., cut-out speed) values for multiple different wind turbines as a function of the associated wind farm density. The graph 260 illustrates how rated output may change with increasing wind farm density. In some examples, a fitted curve 265 is generated based on the rated output values in the graph 260.

A positive correlation in the fitted curve 265 may suggest that as wind farm density increases, the cut-out speed, or the wind speed at which a turbine stops producing power, also slightly increases. As previously discussed, in denser wind farms, the closer proximity of turbines can lead to a channeling effect, where some upstream turbines experience a higher effective wind speed due to the funneling of air between neighboring turbines. This higher wind speed may potentially cause these turbines to reach their maximum rated power output at a slightly lower actual wind speed compared to turbines in less dense layouts. However, the increased wake effects in denser wind farms may also play a role. As the wind passes through upstream turbines, it loses energy and creates turbulence, leading to a lower effective wind speed for downstream turbines. This can counteract the channeling effect to some extent, potentially causing the rated output wind speed to remain relatively stable or even increase slightly in some cases.

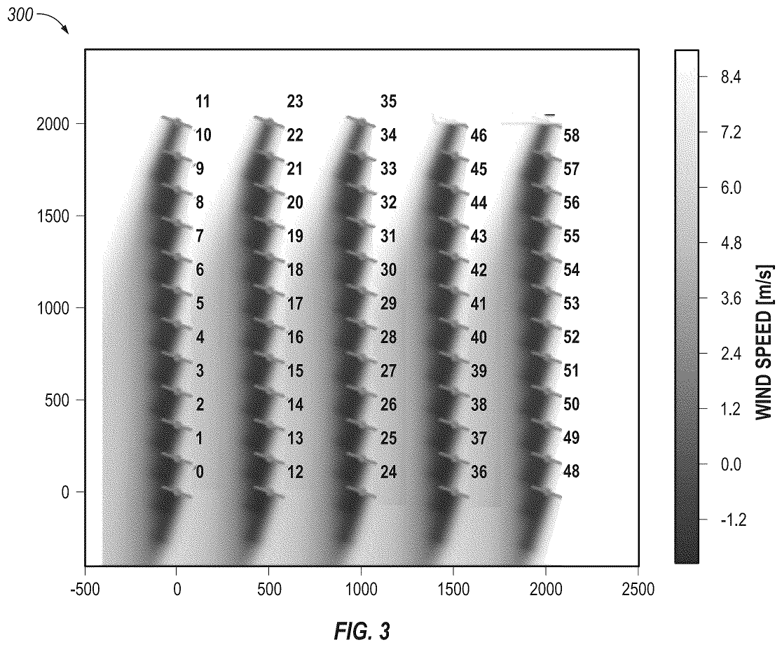

FIG. 3 shows a schematic illustration 300 of a wake model applied to an example grid formation wind farm is shown. The wake model may be used to demonstrate wake effects on a wind farm. The schematic illustration 300 illustrates the xy-position of wind turbines in the farm. The schematic illustration 300 also illustrates a wind speed heat map at various positions in the wind farm.

For example, the darker shaded areas indicate lower wind speeds, while the lighter shaded areas indicate higher wind speeds. FIG. 3 shows that wind speed is not uniform across the wind farm, with some areas experiencing reduced wind speeds relative to others, which may be due to wake effects. This is evident in the darker-shaded areas behind each turbine relative to the direction of the wind.

In FIG. 3, the wind turbines are arranged in rows with some spacing between them. Such an arrangement is common in wind farms to increase energy capture while reducing the negative impacts of the wake effect. However, the figure shows that even with this layout, wake effects still have an impact on the wind speed distribution across the wind farm. This may highlight the value of considering wake effects in wind farm design to improve energy production.

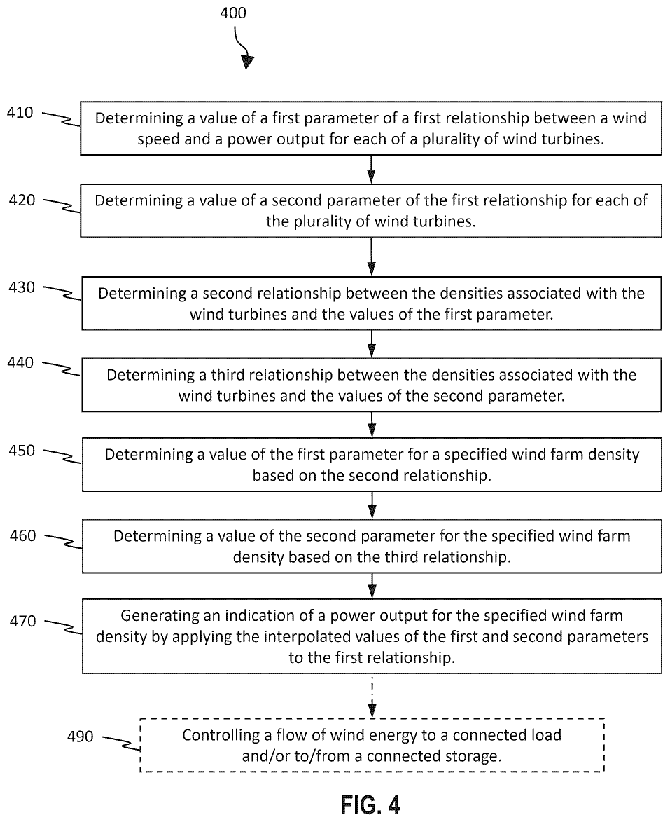

FIG. 4 illustrates a method 400 for estimating wind farm power output according to an embodiment of the disclosure. The method 400 may also be used to predict an integration of wind energy into an electrical grid based on power output for the specified wind farm density.

At step 410, the method 400 includes determining a value of a first parameter of a first relationship between a wind speed and a power output for each of a plurality of wind turbines. The first relationship may refer to a power curve. This relationship may be non-linear and may depend on various factors, including turbine design, blade characteristics, air density, and environmental conditions. The first relationship may include a function (e.g., Equation 1 or Equation 2). The power curve is represented as a graph, with wind speed on the x-axis and power output on the y-axis. The first parameter may refer to specific characteristics or attributes of the power curve that influence its shape and, consequently, the performance of the turbine. Examples of such parameters include incident wind speed, saturation, rate of growth, wind speed range associated with the greatest rate of change of power, or shaping parameter.

A dataset comprising multiple wind turbines from different wind farms, ideally with varying densities (i.e., number of turbines per unit area), may be used. This dataset may capture the variability in power curve parameters across different turbine models and environmental conditions, increasing generalizability of a model. Such data also may provide a basis for establishing relationships between power curve parameters and wind farm density. Step 410 may include analyzing historical power output data for each turbine in the dataset to extract the value of the specific parameters of interest. This may include directly measuring the parameter from the data (e.g., observing the cut-in speed from wind speed and power output records), fitting a mathematical model to the power curve data and extracting the parameter as a model coefficient, or using statistical techniques to estimate the parameter based on the data distribution.

Further, the values of the first parameter may be based on simulated power output data for a plurality of simulated wind turbines having different densities. While historical power output data from real-world wind turbines may provide valuable insights into the relationship between power curve parameters and wind farm density, it may have inherent limitations. Real-world data collection can be expensive, time-consuming, and restricted by the availability of suitable wind farms. Additionally, the range of densities and turbine configurations represented in real-world data may be limited. To address these limitations, the method 400 may incorporate simulated power output data into the determination of the first and second parameter values. This may include using computational models to simulate the behavior of wind turbines under various conditions, including different wind speeds, turbine designs, and wind farm densities. By simulating a wide range of scenarios, more comprehensive and diverse datasets may be generated than what is typically available solely from real-world sources. This may allow for a more thorough exploration of the parameter space and a more robust estimation of the relationships between power curve parameters and wind farm density.

By determining the values of the first parameter (and subsequently other parameters) for a set of wind turbines, the method aids in establishing a foundation for understanding how these parameters vary with wind farm density. This understanding may subsequently be utilized to determine (e.g., interpolate or extrapolate) parameter values for new wind farms, allowing for power output predictions and possible optimization.

At step 420, the method 400 continues with determining a value of a second parameter of the first relationship for each of the plurality of wind turbines. The values of the first parameter and the second parameter are based on historical power output data for each of the plurality of wind turbines, and at least some of the plurality of wind turbines are associated with wind farms having different densities.

Similar to the first parameter, the second parameter refers to another distinct characteristic or attribute of the power curve that affects the performance of a wind turbine. Building on the examples from the first parameter, the second parameter may be a different attribute, such as a different wind speed value (e.g., cut-out speed if the first parameter was cut-in speed) or a different characteristic of the power curve (e.g., saturation power if the first parameter was the rate of growth). Real-world data collected from the actual operation of wind turbines may be relied upon. This historical data may include wind speed and power output measurements over time. By analyzing this data, patterns and relationships between wind speed, power output, and other relevant factors may be identified.

As indicated for the first parameter, the values of the second parameter may be based on simulated power output data for a plurality of simulated wind turbines having different densities. Also, the method 400 may draw upon data from multiple wind turbines situated in various wind farms with varying densities. Capturing a wide range of possible power curve behaviors and understanding how these behaviors are influenced by turbine density may enhance method performance.

Similar to the first parameter, step 420 may include analyzing the historical (or simulated) power output data for each turbine to extract the value of the second parameter. This process could include various techniques, such as curve fitting, statistical analysis, or machine learning algorithms.

By determining the values of both the first and second parameters for a set of wind turbines across different wind farm densities, the method may create a comprehensive dataset that can be used to establish correlative relationships between these parameters and turbine density. These relationships may then be used to determine (e.g., interpolate or extrapolate) parameter values for new or planned wind farms, enabling rapid power output predictions and potential optimization.

At step 430, the method 400 continues with determining a second relationship between the densities associated with the wind turbines and the values of the first parameter. The second relationship may refer to a mathematical or statistical function that models the correlation between wind farm density (the independent variable) and the values of the first power curve parameter (the dependent variable). It may quantify how changes in turbine density affect the first parameter, which could be any of the parameters mentioned earlier (e.g., cut-in speed, rated speed) as specific values (e.g., cut-in speed in m/s, rated power in kW) determined for each wind turbine in the dataset. This relationship is not assumed to be linear; it may be a polynomial, exponential, or any other suitable function that most appropriately captures the observed trend in the data. For example, the second relationship is the fitted curve of one of FIGS. 2A-2F.

Utilizing densities associated with wind turbines in determining the second relationship underscores the use of data from multiple wind turbines situated in wind farms with varying densities. By analyzing data from different densities, the method 400 may better identify trends and patterns in how the first parameter changes as the number of turbines per unit area increases or decreases.

Step 430 may include analyzing relationships between the values of the first parameter and the corresponding wind farm densities. This may allow the establishment of a mathematical function that most appropriately fits the observed data points, effectively capturing the trend of how the first parameter changes with density. This may be achieved through various techniques like regression analysis, curve fitting, or machine learning. Regression analysis includes fitting a regression model (e.g., linear, polynomial, exponential) to the data to find the equation that appropriately predicts the first parameter based on density. Curve fitting includes using numerical optimization techniques to find a curve that generally reduces the error between the predicted and observed values of the first parameter. Machine learning includes employing algorithms to learn the relationship between density and the first parameter from the data.

At step 440, the method 400 continues with determining a third relationship between the densities associated with the wind turbines and the values of the second parameter. Step 440 parallels the determination of the second relationship in step 430 discussed earlier but focuses on a different parameter. The third relationship may signify a mathematical model or function that describes how the value of the second parameter of the power curve changes with varying wind farm densities. Similar to the second relationship, this third relationship is not assumed to be linear; it could be polynomial, exponential, or any other suitable function that suitably captures the observed trend in the data. This third relationship may be referred to as a best-fit curve for the second parameter of the first relationship as it may be derived through a curve-fitting process.

As in step 430, at step 440 a range of densities from the plurality of wind turbines in the dataset, which ideally includes turbines from wind farms with different layouts and densities, may be utilized. By analyzing data from different densities, the method 400 can better identify trends and patterns in how the first parameter changes as the number of turbines per unit area increases or decreases.

The second parameter represents another distinct characteristic of the power curve that affects the performance of a wind turbine. Building on the examples from the first parameter, the second parameter could be saturation power, rate of growth, shape parameter, wake effect parameters, or other relevant characteristics not chosen as the first parameter.

Step 440 is analogous to determining the second relationship in step 430, but step 440 focuses on the second parameter. Step 440 includes analyzing the relationship between the values of the second parameter and the corresponding wind farm densities. This may allow the discovery of a mathematical function that appropriately fits the observed data points, effectively capturing the trend of how the second parameter changes with density. Similar techniques like regression analysis, curve fitting, or machine learning can be used for this purpose.

The third relationship, along with the second relationship, may provide a comprehensive understanding of how multiple power curve parameters are influenced by wind farm density. This may allow the prediction of multiple parameters for new or planned wind farms based on their density, leading to more accurate power output predictions and better-optimized wind farm designs.

At step 450, the method 400 continues with determining (e.g., by interpolating or extrapolating) a value of the first parameter for a specified wind farm density based on the second relationship. Specified wind farm density (or “specified density”) may refer to the density of wind turbines in a new or planned wind farm for which one aims to predict power output. Specified wind farm density may be a known input to the method and is usually expressed as the number of turbines per unit area. The specified wind farm density can either fall within or outside the range of densities used to derive the third relationship. Thus, step 450 may be used to apply previously established relationships between a power curve parameter and wind farm density to estimate the parameter value for a new or planned wind farm.

The specified wind farm density may be a known input to the method 400 and is typically expressed as a number of turbines per unit area (e.g., turbines per square kilometer). The specified wind farm density may fall within or outside the range of densities used to establish the second relationship. As explained earlier, the second relationship may be a mathematical function or curve that describes how the value of the first parameter of the power curve changes with varying wind farm densities. This relationship may be determined by analyzing historical or simulated data from a plurality of wind turbines in different wind farms.

If the specified wind farm density falls within the range of densities used to establish the second relationship, interpolation may be used. Interpolation may include estimating the value of the first parameter by finding the corresponding point on the second relationship curve. Various interpolation techniques can be used, such as linear interpolation, polynomial interpolation, or spline interpolation. If the specified wind farm density falls outside the range of densities used to establish the second relationship, extrapolation may be used. Extrapolation may include extending the second relationship curve beyond the known data points to estimate the value of the first parameter. Extrapolation is generally less reliable than interpolation, as it relies on the assumption that the relationship continues to hold beyond the observed training dataset coverage.

At step 460, the method 400 continues with determining (e.g., by interpolating or extrapolating) a value of the second parameter for the specified wind farm density based on the third relationship. Much like step 450 discussing the first parameter, step 460 applies the established relationship between a power curve parameter and wind farm density to estimate the value of the parameter for a new or planned wind farm. However, step 460 focuses on the second parameter of the power curve and the third relationship that describes its variation with density.

The third relationship may be a mathematical function or curve that describes how the value of the second parameter of the power curve changes with varying wind farm densities. Similar to the second relationship, it could be linear, polynomial, exponential, or any other suitable form that appropriately fits the observed data. This relationship may be established by analyzing historical or simulated data from wind turbines across different wind farm densities. As with the first parameter, a value of the second parameter may be interpolated or extrapolated.

Determining a value of the first and second parameters in step 450 and step 460 may allow the method 400 to customize the power curve model further for the specific wind farm density under consideration. By estimating the value of the second parameter based on the third relationship, the model can more accurately capture the impact of density on another aspect of the performance of the turbine. This may lead to more accurate and reliable power output predictions, which may further aid in improving wind farm design, operation, and integration into the electrical grid.

At step 470, the method 400 continues with generating an indication of a power output for the specified wind farm density by applying the interpolated values of the first and second parameters to the first relationship. Step 470 may be the final step of the method 400, where the knowledge gained from previous steps may be used to predict the power output of a specified (e.g., new or planned) wind farm with a particular density.

Interpolated (or extrapolated) values of the first and second parameters represent the estimated characteristics of the power curve for the specified wind farm density. At this stage, these values have been obtained through the interpolation (or extrapolation) process described earlier, which utilizes the relationships between power curve parameters and wind farm density.

As previously discussed, the first relationship refers to the power curve model that defines the relationship between wind speed and power output for a wind turbine. This model may incorporate various parameters (including the first and second parameters) that influence the shape and behavior of the curve. The specific form of this model can vary, but it is typically a mathematical function that takes wind speed as input and produces power output as output.

Step 470 includes substituting the determined values of the first and second parameters into the power curve model. This may effectively customize the model to the specific conditions of the specified wind farm density. With the customized power curve model, the method 400 can now predict the power output of the specified wind farm density for a range of wind speeds. This prediction can be presented in various forms, such as a table of power output values corresponding to different wind speeds, a graphical representation of the power curve (e.g., as shown in the exemplary power curve 160 in FIG. 1B), or a statistical distribution of expected power output based on the wind speed distribution at the wind farm site.

Step 470 aids in providing an estimate of the power output that can be expected from the new or planned wind farm. This information can be used for a variety of purposes, including wind farm design, financial modeling, or grid integration. For example, in wind farm design, the predicted power output can guide the enhanced placement of wind turbines within the farm, considering factors like wake effects and terrain. Further, the predicted power output may be useful for estimating the economic viability of the wind farm project, including potential revenue generation and return on investment. In grid integration, the power output prediction can be used to assess the impact of the wind farm on the electrical grid, helping to enhance stable and reliable power delivery.

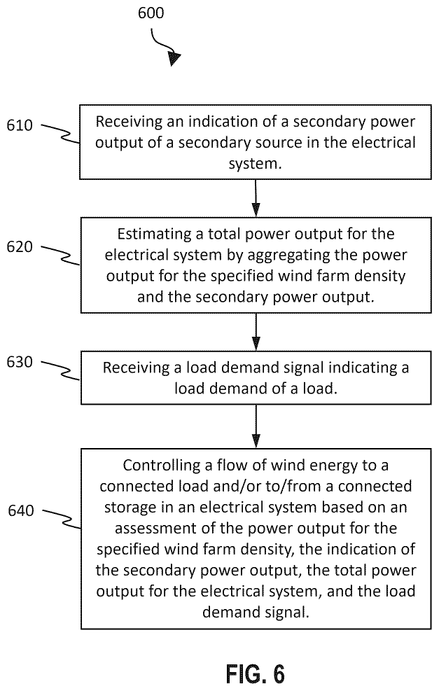

The method 400 may end after generating an indication of the power output for the specified wind farm density (e.g., step 470). Alternatively, the indication of the power output for the specified wind farm density may be utilized to control a flow of wind energy to a connected load and/or to/from a connected storage (e.g., battery storage) at step 490. Step 490 is discussed in further detail below with respect to FIG. 6.

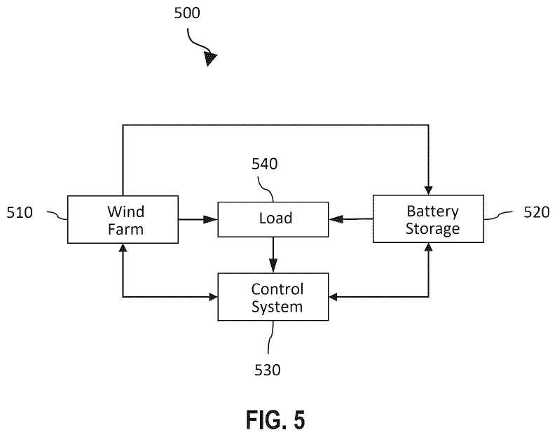

FIG. 5 illustrates a block diagram of a system 500 in accordance with an embodiment of this disclosure. The system 500 includes a wind farm 510, a battery storage 520, a control system 530, and a connected load 540. The system 500 may include additional components (e.g., inverters, generators, transmission lines, additional loads) and may be connected to a larger grid.

The wind farm 510 is a power source in the system 500. The battery storage 520 is an energy storage system that may be used to buffer fluctuations in wind power and maintain electrical system or grid stability. The control system 530 receives power output data from the wind farm 510 and may control various components. The connected load 540 represents electrical demand within the system 500.

The wind farm 510 may transmit wind farm power output estimates to the control system 530. The control system 530 may send commands to the wind farm 510 to adjust turbine settings or power output based on the estimated power and conditions of the system 500. The wind farm 510 and the battery storage 520 may provide power to the connected load 540. The connected load 540 may communicate its power requirements to the control system 530 via a load demand signal. The control system 530 may manage charging and discharging of the battery storage 520 based on wind power availability from the wind farm 510 and demand from the connected load 540.

For example, if the predicted wind farm power output is less than the load demand, the control system 530 may command the battery storage 520 to discharge, supplementing the wind power to meet the load requirements. Conversely, if the predicted wind farm power output exceeds the load demand, the control system 530 may direct the excess energy to charge the battery storage 520, effectively storing it for later use when wind generation is low. In scenarios where the wind farm power output surpasses the load demand, and the battery storage 520 is already fully charged, the control system 530 might instruct the wind farm inverter(s) (not shown) to curtail the wind farm's power output. Such instruction to curtail power output may prevent overgeneration and aid in maintaining the stability of the electrical system. Additional examples of decision-making by the control system could encompass other conditional branches, such as grid interaction, demand response, or economic optimization.

In these ways, the control system 530 may balance power supply from the wind farm 510 and battery storage 520 to meet the varying demand by the connected load 540 in the system 500. The connection between the wind farm 510 and the control system 530 enables the use of power output data (e.g., as determined in step 470, described above) for dynamic control and optimization of the system 500. The battery storage 520 and its connection to the control system 530 emphasize the ability of the system 500 to store excess wind energy, which can thus be utilized during periods of low generation, improving overall energy balance. Control signals from the control system 530 to the wind farm 510 and battery storage 520 demonstrate how the system 500 may proactively manage fluctuations in wind power to maintain grid stability.

FIG. 6 illustrates a method 600 for controlling energy distribution in an electrical system. As indicated earlier, the method 600 is an example of step 490 illustrated in FIG. 4. The method 600 may extend wind farm power output prediction to the broader context of electrical grid integration. This highlights the ability to incorporate data from other power sources within the grid to assess the overall impact of wind energy integration.

At step 610, the method 600 includes receiving an indication of a secondary power output of a secondary source (e.g., the battery storage 520) in an electrical system (e.g., the system 500). The secondary source may encompass any entity or facility contributing to the power supply of the electrical system, excluding the wind farm (e.g., the wind farm 510) whose power output is being predicted. The secondary power output may refer to the electrical power generated by the secondary source. The secondary power source could include traditional power plants (e.g., coal, natural gas, nuclear), other renewable energy sources (e.g., solar, hydro, biomass), or energy storage systems (e.g., batteries, pumped hydro storage). For example, the secondary power source could be a single power plant, a collection of distributed energy resources, or even a regional power grid. The type and number of secondary sources considered may vary depending on the scope and scale of the analysis.

The indication of secondary power output may refer to a signal, measurement, or data that provides information about the power being generated by the secondary source. The indication could be “real-time” (e.g., a continuous stream of data reflecting the instantaneous power output of the secondary source), historical (e.g., recorded data of past power output, which can be used to analyze trends and patterns), or forecasted (e.g., predicted power output based on weather forecasts, demand projections, or other relevant factors). The indication could be received through various communication channels, such as direct measurements (e.g., sensors or meters installed at the secondary source transmit data directly to the system performing the prediction), data aggregation (e.g., a centralized system collects and processes data from multiple secondary sources), or external data providers (e.g., third-party organizations provide power output data for various sources).

The purpose of receiving an indication of secondary power output may be to enable the method 600 to assess the combined impact of wind energy and other power sources on the electrical system. By aggregating the predicted wind farm output with the secondary power output, the method 600 may be able to estimate the total power available to the electrical system. This may be useful for electrical system and/or grid stability analysis, capacity planning, or economic analysis. Grid stability analysis may include understanding fluctuations and variability of both wind and secondary power sources to assess the stability and reliability of a grid when integrating a new wind farm. Capacity planning may include evaluating total power output to allow grid operators to determine if the existing infrastructure can handle the additional wind power or if upgrades are needed. By incorporating the value of the secondary power output, the method 400 may be able to provide a more comprehensive economic assessment of the wind farm project, considering its contribution to the overall energy market.

At step 620, the method 600 continues with estimating a total power output for the electrical system by aggregating the power output for the specified wind farm density and the secondary power output. Step 620 includes combining the predicted power output of the wind farm based on its density and previously described steps in the method 400 (e.g., the indication of the power output for the specified wind farm density) with the power output of other existing energy sources (secondary sources) in the system/grid.

Electrical grids are complex systems that balance the supply and demand of electricity. This balance is typically achieved by carefully controlling the frequency (e.g., 60 Hz in the US) and voltage of the electricity flowing through the grid. Integrating a new power generation source, such as a wind farm, can alter the dynamics of the grid. To ensure the stability and reliability of the grid, it may be useful to understand how the power output of the wind farm will interact with the output from other sources.

The aggregation process may include combining the power output data from different sources to estimate the total power available to the electrical system or grid at any given time. This may be done in various ways, depending on the nature of the data and the desired level of accuracy. Some common aggregation methods include simple summation, weighted averaging, or time series analysis. For example, if the power output data for each source is available at the same time intervals, they can be added together to obtain the total power output. Alternatively, if the power output data has different time resolutions or reliability levels, a weighted average can be used, where the contribution of each source is weighted based on its relative importance or accuracy. Furthermore, if the power output data is available as time series, more sophisticated techniques like correlation analysis or forecasting models can be used to predict the combined output and account for potential fluctuations and intermittency.

The calculated total power output represents an estimate of the combined power that all sources (including the wind farm) can contribute to the electrical system (i.e., estimated total power output for the electrical system). This estimate may be useful for assessing the capacity of the system to handle the additional wind power and identifying potential challenges or opportunities related to system integration.

Step 620 helps to address the broader context of wind energy integration into the electrical system. By predicting wind farm performance, embodiments described herein may aid in enhanced integration of wind farm power output with the power output of other sources (and/or battery storage) to satisfy connected load demand. Such integration-related information may be useful for system/grid operators, utilities, and policymakers to make informed decisions regarding renewable energy integration strategies, infrastructure investments, and energy market regulations.

At step 630, the method 600 continues with receiving a load demand signal indicating a load demand of a load (e.g., the connected load 540) within the electrical system (e.g., the system 500). The load within an electrical system may represent a collective power consumption of various devices and appliances, exhibiting dynamic behavior. Demand for electricity may fluctuate throughout the day and may be influenced by factors such as time of day, weather conditions, and user behavior. To improve grid stability and appropriate power utilization, the control system of an electrical system may need to have awareness of the load demand. This is where the load demand signal comes into play. This load demand signal, transmitted from the load to the control system, may provide information about the power requirements of the load. The load demand signal may be generated in various ways (e.g., using smart meters, advanced metering infrastructure (AMI), or other communication technologies). The load demand signal may also incorporate predictive models or historical usage patterns to anticipate future power needs.

Accuracy and timeliness of the load demand signal may aid the control system to make informed decisions about power dispatch, energy storage management, and grid interaction. By receiving this signal, the control system may be able to adjust the flow of wind energy into the electrical system to maintain a balance between power generation and consumption, improving grid stability and optimal power utilization.

At step 640, the method 600 concludes with controlling a flow of wind energy into the electrical system. This control process may be facilitated by a control system (e.g., the control system 530) that receives information about power output of the wind farm (e.g., the wind farm 510), the load demand (e.g., from the connected load 540) within the electrical system (e.g., the system 500), and other relevant electrical system or grid parameters.

The flow of wind energy into the electrical system may be based on an assessment of the power output for the specified wind farm density, the indication of the secondary power output, the total power output for the electrical system, and the load demand signal. The control system may utilize this information to perform an assessment of the energy balance within the electrical system. This assessment may include, for example, comparing the estimated total power output with the load demand signal to identify any surplus or deficit of power, evaluating the variability and intermittency of wind power based on the power output for the specified wind farm density, considering the contribution of secondary power sources based on the indication of the secondary power output, or assessing the overall capacity of the electrical system to accommodate the available power generation.

Based on this assessment, the control system may determine the appropriate control actions. Such control actions of the control system may include adjusting wind farm output, managing energy storage, managing grid interaction, and implementing demand response. To adjust wind farm output, the control system may send signals to the wind farm to curtail (reduce) or increase its power output as needed to match the load demand. If the system includes battery storage (e.g., the battery storage 520) or other energy storage devices, the control system may direct the charging or discharging of these devices to store excess wind energy or supply power during periods of low wind generation. Further, if the microgrid is connected to the main power grid, the control system may manage the import or export of power to balance the system and potentially participate in energy markets. Additionally, the control system may implement demand response strategies, where certain loads are temporarily adjusted or curtailed to match the available wind power.

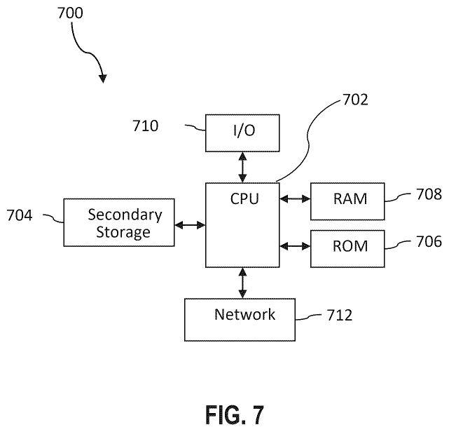

Referring now to FIG. 7, a computer system 700 suitable for implementing one or more embodiments disclosed herein is shown. Any of the systems and methods disclosed herein can be carried out (e.g., entirely or partially) on a computer or other device comprising a processor (e.g., a desktop computer, a laptop computer, a tablet, a server, a smartphone, or some combination thereof). The computer system 700 includes a processor 702 (which may be referred to as a central processor unit or CPU) that is in communication with memory devices including secondary storage 704, read only memory (ROM) 706, random access memory (RAM) 708, input/output (I/O) devices 710, and network connectivity devices 712. The processor 702 may be implemented as one or more CPU chips.

It is understood that by programming and/or loading executable instructions onto the computer system 700, at least one of the CPUs 702, the RAM 708, and the ROM 706 are changed, transforming the computer system 700 in part into a particular machine or apparatus having the novel functionality taught by the present disclosure. Thus, the RAM 708 and/or the ROM 706 may comprise a non-transitory machine-readable (or computer-readable) medium that may include instructions (which may be referred to herein as machine-readable instructions) that are executable by CPU 702 to provide functionality to computer system 700. Thus, in some embodiments, a machine-readable instructions stored on a memory may be executed on a processor, so as to configured the processor to carry out some or all of the features of the methods described herein (e.g., method 700).

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware (for example in an application-specific integrated circuit (ASIC), or a field-programmable gate array (FPGA)) because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 700 is turned on or booted, the CPU 702 may execute a computer program or application. For example, the CPU 702 may execute software or firmware stored in the ROM 706 or stored in the RAM 708. In some cases, on boot and/or when the application is initiated, the CPU 702 may copy the application or portions of the application from the secondary storage 704 to the RAM 708 or to memory space within the CPU 702 itself, and the CPU 702 may then execute instructions of which the application is comprised. In some cases, the CPU 702 may copy the application or portions of the application from memory accessed via the network connectivity devices 712 or via the I/O devices 710 to the RAM 708 or to memory space within the CPU 702, and the CPU 702 may then execute instructions of which the application is comprised. During execution, an application may load instructions into the CPU 702, for example load some of the instructions of the application into a cache of the CPU 702. In some contexts, an application that is executed may be said to configure the CPU 702 to do something, e.g., to configure the CPU 702 to perform the function or functions promoted by the subject application. When the CPU 702 is configured in this way by the application, the CPU 702 becomes a specific purpose computer or a specific purpose machine.

The secondary storage 704 is typically comprised of one or more disk drives or tape drives and is used for non-volatile storage of data and as an over-flow data storage device if RAM 708 is not large enough to hold all working data. Secondary storage 704 may be used to store programs which are loaded into RAM 708 when such programs are selected for execution. The ROM 706 is used to store instructions and perhaps data which are read during program execution. ROM 706 is a non-volatile memory device which typically has a small memory capacity relative to the larger memory capacity of secondary storage 704. The RAM 708 is used to store volatile data and perhaps to store instructions. Access to both ROM 706 and RAM 708 is typically faster than secondary storage 704. The secondary storage 704, the RAM 708, and/or the ROM 706 may be referred to in some contexts as computer readable storage media and/or non-transitory computer readable media.

I/O devices 710 may include printers, video monitors, electronic displays (aka display devices—e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 712 may take the form of modems, modem banks, Ethernet cards, Omni-Path Architecture (OPA), InfiniBand (IB), universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 712 may enable the processor 702 to communicate with the Internet or one or more intranets. With such a network connection, it is contemplated that the processor 702 may receive information from the network, or may output information to the network (e.g., to an event database) in the course of performing the methods described herein. Such information, which is represented as a sequence of instructions to be executed using processor 702, may be received from and outputted to the network, for example, in the form of a computer data signal embodied in a carrier wave.

Such information, which may include data or instructions to be executed using processor 702 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 702 executes instructions, codes, computer programs, scripts which it accesses from hard disk, floppy disk, optical disk, solid state drives (SSD) (these various disk-based systems may all be considered secondary storage 704), flash drive, ROM 706, RAM 708, or the network connectivity devices 712. While only one processor 702 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 704, for example, hard drives, floppy disks, optical disks, and/or other device, the ROM 706, and/or the RAM 708 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 704, to the ROM 706, to the RAM 708, and/or to other non-volatile memory and volatile memory of the computer system 700. The processor 702 may process the executable instructions and/or data structures in part by directly accessing the computer program product, for example by reading from a CD-ROM disk inserted into a disk drive peripheral of the computer system 700. Alternatively, the processor 702 may process the executable instructions and/or data structures by remotely accessing the computer program product, for example by downloading the executable instructions and/or data structures from a remote server through the network connectivity devices 712. The computer program product may comprise instructions that promote the loading and/or copying of data, data structures, files, and/or executable instructions to the secondary storage 704, to the ROM 706, to the RAM 708, and/or to other non-volatile memory and volatile memory of the computer system 700.

In some contexts, the secondary storage 704, the ROM 706, and the RAM 708 may be referred to as a non-transitory computer-readable medium or a computer readable storage media. A dynamic RAM embodiment of the RAM 708, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 702 may comprise an internal RAM, an internal ROM, a cache memory, and/or other internal non-transitory storage blocks, sections, or components that may be referred to in some contexts as non-transitory computer-readable media or computer-readable storage media. At least some, if not all, of the steps or “blocks” of the methods 400 and 600 shown in FIGS. 4 and 6, respectively, may be executed by the computer system 700 shown in FIG. 7, although it is to be understood that at least some of the steps of the methods 400 and 600 may be executed by systems other than computer system 700.

Appendix A is included and incorporated herein.

While several embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

While several embodiments have been provided, the disclosed systems and methods may be embodied in other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented. Likewise, where single components, apparatuses, or systems are described as performing functions, multiple such components, apparatuses, or systems may implement the functions.

The term “about” means a range including ±10% of the subsequent number unless otherwise stated. Where single components, apparatuses, or systems are described as performing functions, multiple such components, apparatuses, or systems may implement the functions.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method, comprising:
determining a value of a first parameter of a first relationship between a wind speed and a power output for each of a plurality of wind turbines;
determining a value of a second parameter of the first relationship for each of the plurality of wind turbines, wherein the values of the first parameter and the second parameter are based on historical power output data for each of the plurality of wind turbines, and wherein at least some of the plurality of wind turbines are associated with wind farms having different densities;
determining a second relationship between the densities associated with the wind turbines and the values of the first parameter;
determining a third relationship between the densities associated with the wind turbines and the values of the second parameter;
determining a value of the first parameter for a specified wind farm density based on the second relationship;
determining a value of the second parameter for the specified wind farm density based on the third relationship; and
generating an indication of a power output for the specified wind farm density by applying the determined values of the first and second parameters to the first relationship.

2. The method of claim 1, wherein the first relationship comprises:
$${f}_{r} ( v ) = \frac{s + b}{{[ 1 + {e}^{- r ( v - {v}_{t} )} ]}^{p}} - c ,$$
wherein v is a value of an incident wind speed, s is a value of a power output saturation, r is a value of a rate of growth, vₜ is a value of wind speed range associated with a greatest rate of change of power, p is a value of a shaping parameter, and b and c are constants chosen such that fᵣ(v_{cut-in})=0 and fᵣ(v_{cut-out})=s, and
wherein each of the first parameter and the second parameter is one of an incident wind speed, a power output saturation, a rate of growth, a wind speed range associated with a greatest rate of change of power, or a shaping parameter.

3. The method of claim 2, wherein the first relationship further comprises:
$${f}_{g} ( v , w ) = {f}_{r} ( v ) ( 1 - {p}_{h} ( {e}^{- s {\vert w - {p}_{c} \vert}^{{p}_{s}}} ) ) ,$$
wherein w is a value of an incident wind direction, p_{c} is a value of a wake peak center, pₕ is a value of a wake peak height, and pₛ is a value of a wake peak width, and
wherein each of the first parameter and the second parameter is one of an incident wind speed, an incident wind direction, a power output saturation, a rate of growth, a wind speed range associated with a greatest rate of change of power, a shaping parameter, a wake peak center, a wake peak height, or a wake peak width.

4. The method of claim 1, wherein the second relationship comprises a first curve fitted to the values of the first parameter as a function of wind farm density, and wherein the third relationship comprises a second curve fitted to the values of the second parameter as a function of wind farm density.

5. The method of claim 4, wherein determining the first value comprises determining a value of the first curve for the specified wind farm density, and wherein determining the second value comprises determining a value of the second curve for the specified wind farm density.

6. The method of claim 1, wherein the values of the first parameter and the second parameter are further based on simulated power output data for a plurality of simulated wind turbines having different densities.

7. The method of claim 1, further comprising:
receiving an indication of a secondary power output of a secondary source in an electrical system;
estimating a total power output for the electrical system by aggregating the power output for the specified wind farm density and the secondary power output;
receiving a load demand signal indicating a load demand of a load; and
controlling a flow of wind energy into the electrical system based on an assessment of the power output for the specified wind farm density, the indication of the secondary power output, the total power output for the electrical system, and the load demand signal.

8. An electronic device, comprising:
one or more processors; and
a memory coupled to the one or more processors and storing instructions that, when executed by the one or more processors, cause the electronic device to be configured to:
determine a value of a first parameter of a first relationship between a wind speed and a power output for each of a plurality of wind turbines;
determine a value of a second parameter of the first relationship for each of the plurality of wind turbines, wherein the values of the first parameter and the second parameter are based on historical power output data for each of the plurality of wind turbines, and wherein at least some of the plurality of wind turbines are associated with wind farms having different densities;
determine a second relationship between the densities associated with the wind turbines and the values of the first parameter;
determine a third relationship between the densities associated with the wind turbines and the values of the second parameter;
determine a value of the first parameter for a specified wind farm density based on the second relationship;
determine a value of the second parameter for the specified wind farm density based on the third relationship; and
generate an indication of a power output for the specified wind farm density by applying the determined values of the first and second parameters to the first relationship.

9. The electronic device of claim 8, wherein the first relationship comprises:
$${f}_{r} ( v ) = \frac{s + b}{{[ 1 + {e}^{- r ( v - {v}_{t} )} ]}^{p}} - c ,$$
wherein v is a value of an incident wind speed, s is a value of a power output saturation, r is a value of a rate of growth, vₜ is a value of wind speed range associated with a greatest rate of change of power, p is a value of a shaping parameter, and b and c are constants chosen such that fᵣ(v_{cut-in})=0 and fᵣ(v_{cut-out})=s, and
wherein each of the first parameter and the second parameter is one of an incident wind speed, a power output saturation, a rate of growth, a wind speed region associated with a greatest rate of change of power, or a shaping parameter.

10. The electronic device of claim 9, wherein the first relationship further comprises:
$${f}_{g} ( v , w ) = {f}_{r} ( v ) ( 1 - {p}_{h} ( {e}^{- s {\vert w - {p}_{c} \vert}^{{p}_{s}}} ) ) ,$$
wherein w is a value of an incident wind direction, p_{c} is a value of a wake peak center, pₕ is a value of a wake peak height, and pₛ is a value of a wake peak width, and
wherein each of the first parameter and the second parameter is one of an incident wind speed, an incident wind direction, a power output saturation, a rate of growth, a wind speed region associated with a greatest rate of change of power, a shaping parameter, a wake peak center, a wake peak height, or a wake peak width.

11. The electronic device of claim 8, wherein the second relationship comprises a first curve fitted to the values of the first parameter as a function of wind farm density, and wherein the third relationship comprises a second curve fitted to the values of the second parameter as a function of wind farm density.

12. The electronic device of claim 11, wherein determining the first value comprises determining a value of the first curve for the specified wind farm density, and wherein determining the second value comprises determining a value of the second curve for the specified wind farm density.

13. The electronic device of claim 8, wherein the values of the first parameter and the second parameter are further based on simulated power output data for a plurality of simulated wind turbines having different densities.

14. The electronic device of claim 8, wherein stored instructions, when executed by the one or more processors, cause the electronic device to be further configured to:
receive an indication of a secondary power output of a secondary source in the electrical system;
estimate a total power output for the electrical system by aggregating the power output for the specified wind farm density and the secondary power output;
receive a load demand signal indicating a load demand of a load; and
control a flow of wind energy into the electrical system based on an assessment of the power output for the specified wind farm density, the indication of the secondary power output, the total power output for the electrical system, and the load demand signal.

15. The electronic device of claim 8, further comprising a display device for displaying the indication of a power output.

16. A non-transitory computer-readable medium storing instructions that, when executed by one or more processors of an electronic device, cause the electronic device to be configured to:
determine a value of a first parameter of a first relationship between a wind speed and a power output for each of a plurality of wind turbines;
determine a value of a second parameter of the first relationship for each of the plurality of wind turbines, wherein the values of the first parameter and the second parameter are based on historical power output data for each of the plurality of wind turbines, and wherein at least some of the plurality of wind turbines are associated with wind farms having different densities;
determine a second relationship between the densities associated with the wind turbines and the values of the first parameter;
determine a third relationship between the densities associated with the wind turbines and the values of the second parameter;
determine a value of the first parameter for a specified wind farm density based on the second relationship;
determine a value of the second parameter for the specified wind farm density based on the third relationship; and
generate an indication of a power output for the specified wind farm density by applying the determined values of the first and second parameters to the first relationship.

17. The non-transitory computer-readable medium of claim 16, wherein the first relationship comprises:
$${f}_{r} ( v ) = \frac{s + b}{{[ 1 + {e}^{- r ( v - {v}_{t} )} ]}^{p}} - c ,$$
wherein v is a value of an incident wind speed, s is a value of a power output saturation, r is a value of a rate of growth, vₜ is a value of wind speed range associated with a greatest rate of change of power, p is a value of a shaping parameter, and b and c are constants chosen such that fᵣ(v_{cut-in})=0 and fᵣ(v_{cut-out})=s, and
wherein each of the first parameter and the second parameter is one of an incident wind speed, a power output saturation, a rate of growth, a wind speed range associated with a greatest rate of change of power, or a shaping parameter.

18. The non-transitory computer-readable medium of claim 17, wherein the first relationship further comprises:
$${f}_{g} ( v , w ) = {f}_{r} ( v ) ( 1 - {p}_{h} ( {e}^{- s {\vert w - {p}_{c} \vert}^{{p}_{s}}} ) ) ,$$
wherein w is a value of an incident wind direction, p_{c} is a value of a wake peak center, pₕ is a value of a wake peak height, and pₛ is a value of a wake peak width, and
wherein each of the first parameter and the second parameter is one of an incident wind speed, an incident wind direction, a power output saturation, a rate of growth, a wind speed range associated with a greatest rate of change of power, a shaping parameter, a wake peak center, a wake peak height, or a wake peak width.

19. The non-transitory computer-readable medium of claim 16, wherein the second relationship comprises a first curve fitted to the values of the first parameter as a function of wind farm density, and wherein the third relationship comprises a second curve fitted to the values of the second parameter as a function of wind farm density.

20. The non-transitory computer-readable medium of claim 19, wherein determining the first value comprises determining a value of the first curve for the specified wind farm density, and wherein determining the second value comprises determining a value of the second curve for the specified wind farm density.

21. The non-transitory computer-readable medium of claim 16, wherein the values of the first parameter and the second parameter are further based on simulated power output data for a plurality of simulated wind turbines having different densities.

22. The non-transitory computer-readable medium of claim 16, further configured to:
receive an indication of a secondary power output of a secondary source in the electrical system;
estimate a total power output for the electrical system by aggregating the power output for the specified wind farm density and the secondary power output;
receive a load demand signal indicating a load demand of a load; and
control a flow of wind energy into the electrical system based on an assessment of the power output for the specified wind farm density, the indication of the secondary power output, the total power output for the electrical system, and the load demand signal.
